(19) United States
(12) Patent Application Publication
(10) Pub. No.: US 2006/0116905 A1
(43) Pub. Date: Jun. 1, 2006

(54) In-room / in-home expedited delivery of prescription services

(75) Inventor: Paul Yered, Thousand Oaks, CA (US)

Correspondence Address: MCDERMOTT WILL & EMERY LLP, Suite 3400, 2049 Century Park East, Los Angeles, CA, 90067, US

(73) Assignee: Paul Yered

(21) Appl. No.: 11/269,106

(22) Filed: Nov. 8, 2005

Related U.S. Application Data
(63) Continuation-in-part of application No. 11/187,547, filed on Jul. 22, 2005.
(60) Provisional application No. 60/625,820, filed on Nov. 8, 2004.
(60) Provisional application No. 60/628,505, filed on Nov. 15, 2004.
(60) Provisional application No. 60/628,512, filed on Nov. 15, 2004.
(60) Provisional application No. 60/642,028, filed on Jan. 7, 2005.
(60) Provisional application No. 60/644,091, filed on Jan. 14, 2005.
(60) Provisional application No. 60/646,467, filed on Jan. 24, 2005.
(60) Provisional application No. 60/646,852, filed on Jan. 25, 2005.
(60) Provisional application No. 60/662,721, filed on Mar. 17, 2005.
(60) Provisional application No. 60/662,655, filed on Mar. 17, 2005.
(60) Provisional application No. 60/684,446, filed on May 25, 2005.
(60) Provisional application No. 60/712,729, filed on Aug. 29, 2005.
(60) Provisional application No. 60/590,900, filed on Jul. 23, 2004.
(60) Provisional application No. 60/600,708, filed on Aug. 10, 2004.
(60) Provisional application No. 60/615,449, filed on Oct. 1, 2004.

(51) Int. Cl. G06Q 10/00

(52) U.S. Cl. 705/2

(57) ABSTRACT

A method is described for processing a prescription request for a customer that includes information about the geographic location of the customer. The method includes receiving the request at a prescription claims processing center, including the information about the geographic location of the customer. A prescription service provider that operates at a known geographic location is selected from a plurality of prescription service providers, based on the received geographic location. The received prescription request is routed to the selected prescription service provider, for fulfillment by the selected prescription service provider.

### CROSS-REFERENCE TO RELATED APPLICATIONS

This application is based upon, and claims the benefit of priority under 35 U.S.C. § 119(e) from, U.S. Provisional Patent Application Ser. No. 60/625,820, filed Nov. 8, 2004, entitled “Remote Prescription Order Fulfillment and In-Room Pharmacy at Reduced Costs,” attorney docket no. 71737-014; U.S. Provisional Patent Application Ser. No. 60/628,505, filed Nov. 15, 2004, entitled “Method and System to Lower Prescription Costs,” attorney docket no. 71737-015; U.S. Provisional Patent Application Ser. No. 60/642,028, filed Jan. 7, 2005, entitled “Method and System for Reducing Drug Costs,” filed under attorney docket no. 71737-017; U.S. Provisional Patent Application Ser. No. 60/644,091, filed Jan. 14, 2005, entitled “Retail Pharmacy Prescription Management Coalition (RPPM) USA's Rebate System,” attorney docket no. 71737-019; U.S. Provisional Patent Application Ser. No. 60/646,467, filed Jan. 24, 2005, entitled “System and Method for Reducing Drug Costs by the Coalition of Manufacturer Rebates,” attorney docket no. 71737-020; U.S. Provisional Patent Application Ser. No. 60/662,721, filed Mar. 17, 2005, entitled “System and Method for Reducing Drug Costs,” attorney docket no. 71737-022; U.S. Provisional Patent Application Ser. No. 60/684,446, filed May 25, 2005, entitled “Improved System and Method For Reducing Drug Costs: Retail Pharmacy Prescription Management (RPPM) Coalition,” attorney docket no. 71737-024; and U.S. Provisional Patent Application Ser. No. 60/712,729, filed Aug. 29, 2005, entitled “Cable, Internet Pharmacy, and Interactive Voice Response Prescription Claims Routing System,” attorney docket no. 71737-031. The contents of all of these applications are incorporated herein by reference in their entirety as though fully set forth.

This application is also related to: U.S. Provisional Patent Application Ser. No. 60/590,900, filed Jul. 23, 2004, entitled “System and Method for Reducing Prescription Costs,” attorney docket no. 71737-011; U.S. Provisional Patent Application Ser. No. 60/600,708, filed Aug. 10, 2004, entitled “Advanced System and Method for Reducing Prescription Costs,” attorney docket no. 71737-012; U.S. Provisional Patent Application Ser. No. 60/615,449, filed Oct. 1, 2004, entitled “Computer Operating System to Reduce Prescription Costs, Including Remote Prescription Order Fulfillment,” attorney docket no. 71737-013. The contents of all of these applications are incorporated herein by reference in their entirety as though fully set forth.

This application is also a continuation-in-part of U.S. patent application Ser. No. 11/187,547, filed Jul. 22, 2005, entitled “Method and System for Aggregating Multiple Prescription Claims,” also by inventor Paul Yered. The content of this application is incorporated herein by reference in their entirety as though fully set forth.

### BACKGROUND

A major inconvenience for customers who seek prescription services may be the time and effort necessary to obtain such services. Many retail pharmacy chains may be able to cater only to in-call and/or walk-in prescription requests, because of under-staffing and other reasons. As a result, customers may typically have to wait in long lines in order to submit a prescription request, and may have to spend time dropping off and picking up their prescription orders. This type of inconvenience may also be encountered by customers seeking products and services other than prescriptions, including but not limited to health care, dry cleaning, and grocery shopping.

For these reasons, there is a need for a system and method for providing more convenient and expedited processing and delivery to customers who seek prescription services, as well as other types of services.

### SUMMARY

A method is described for processing a prescription request for a customer that includes information about the geographic location of the customer. The method includes receiving the request at a prescription claims processing center, including the information about the geographic location of the customer. A prescription service provider that operates at a known geographic location is selected from a plurality of prescription service providers, based on the received geographic location. The received prescription request is routed to the selected prescription service provider, for fulfillment by the selected prescription service provider.

A method is described for processing a request for a prescription for a customer that includes information about the geographic location of the customer. The method includes receiving the request at a prescription claims processing center, including the information about the geographic location of the customer. The method includes selecting a prescription service provider operating at a known geographic location from a plurality of prescription service providers, based on the received geographic location. The method includes routing the received request to the selected prescription service provider for fulfillment of the prescription and delivery of the filled prescription to the customer by the selected prescription service provider within a desired time frame.

A system is described for processing a request for a prescription for a customer that includes information about the geographic location of the customer. The system includes a processing system that is configured to receive the request, including the information about the geographic location of the customer. The processing system is further configured to select a prescription service provider operating at a known geographic location from a plurality of prescription service providers, based on the received geographic location, and to route the received request to the selected prescription service provider for fulfillment by the selected prescription service provider.

A method is described for processing a request for a service from a customer that includes information about the geographic location of the customer. The method includes receiving the request at a service request processing center from the customer, including the information about the geographic location of the customer. The method further includes selecting a service provider operating at a known geographic location from a plurality of service providers, based on the received geographic location. The method further includes routing the received request to the selected service provider for delivery of the service by the selected service provider to the customer within a desired time frame.

### BRIEF DESCRIPTION OF THE DRAWINGS

FIG. 1 is a schematic diagram of a system for lowering prescription costs by consolidating and aggregating prescription claims.

FIG. 2 is a conceptual diagram illustrating a flow of operations that may occur between different entities, in one embodiment of methods and systems in which prescription costs are lowered by aggregating claims and by obtaining manufacturer rebates based on the aggregated claims.

FIG. 3 is another conceptual diagram illustrating a flow of operations that may occur between different entities, in another embodiment of methods and systems in which prescription costs are lowered by aggregating claims and obtaining manufacturer rebates based on the aggregated claims.

FIG. 4 is a conceptual diagram illustrating a system and method for lowering prescription costs through individual drug benefit plans implemented by individual pharmacies and/or employers, in competition with outside benefit plans.

FIG. 5 conceptually illustrates an overview of a flow of operations that may occur, in one embodiment of a system and method for providing expedited processing and delivery of prescription services.

FIG. 6 illustrates an exemplary order-screen that may appear on an internal cable network of a TV in a guest's room, to allow the guest to submit an order for expedited in-room delivery of prescriptions.

### DETAILED DESCRIPTION

A method and system are described for processing prescription requests through a centralized prescription claims processing system, i.e. a prescription claims processing center, so as to provide expedited delivery of the prescriptions. For example, same day delivery of the filled prescription may be made to the customer's home, if the customer resides at home when submitting the request, or to a hotel room where the customer is staying, if the customer is a guest of a hotel when submitting the request.

The prescription claims processing center may also implement methods and systems for lowering the cost of prescription drugs by aggregating and consolidating multiple prescription claims. As described below, these methods and systems allow pharmacies, employers, and other purchasers of prescription drugs to unify and consolidate their prescription claims, thereby substantially lowering prescription costs due to the resulting increase in market share.

Manufacturer Rebates Based on Aggregated Claims

In one embodiment of the systems and methods described below, prescription costs may be lowered by obtaining manufacturer rebates based on aggregated prescription claims.

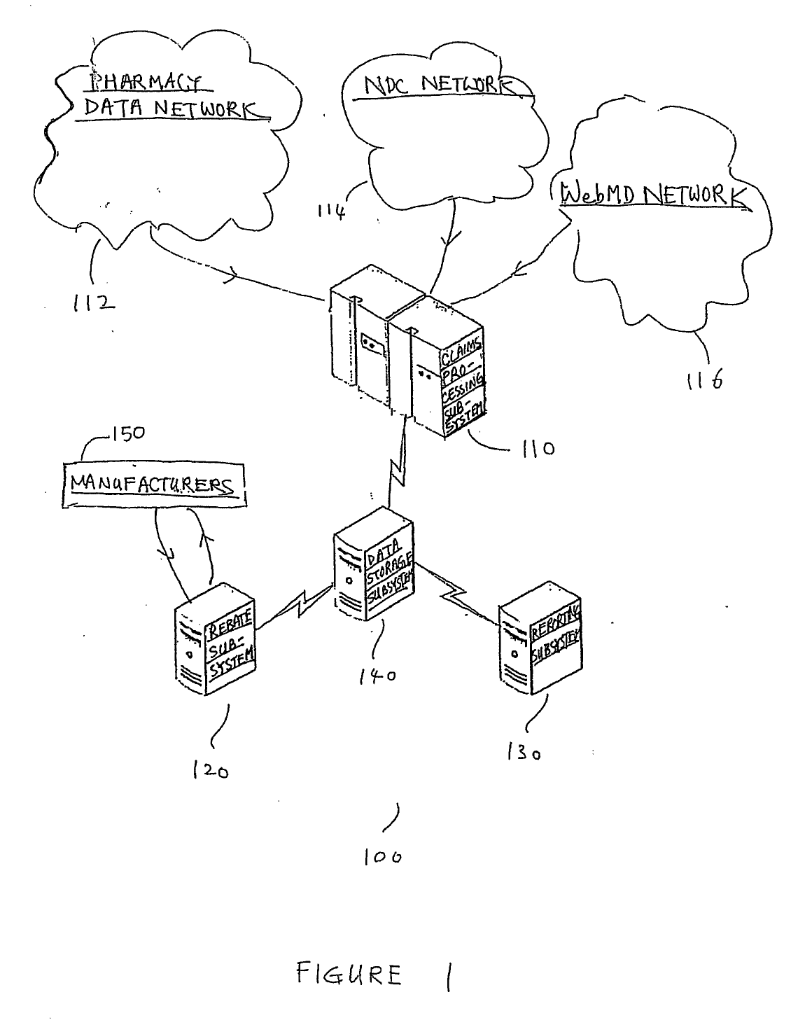

FIG. 1 is a schematic block diagram of a system 100 for lowering prescription costs by consolidating and aggregating prescription claims. In overview, the system 100 includes a claims processing subsystem 110, a rebate subsystem 120, and a data storage subsystem 140. The claims processing subsystem 110 may receive and process claims from many pharmacies, for prescription drugs that are made by many manufacturers of the drugs, e.g. by many drug companies. The received claims may be stored in the data storage subsystem 140. The rebate subsystem 120 may aggregate the claims in the data storage subsystem 140 for the prescriptions made by each manufacturer, and may allocate and distribute rebates to each of the pharmacies, based on the portion of the manufacturer rebates that are attributable to the claims received from each pharmacy.

In one embodiment, a unified and centralized system may be provided to allow most or all of the retail pharmacies and employers in the U.S.A. to combine and unify their prescription claims transmissions, in order to distribute the rebates (which increase in size as a result of such combination and aggregation) to the consumers, the pharmacies, and the employers. Such a system may be called the RPPM (Retail Pharmacy Prescription Management) system, and the method of lowering prescription costs through such a unified and centralized system may be called the RPPM method.

The subsystems within the RPPM system 100, including but not limited to the data storage center or subsystem 140 that stores the consolidated and unified claims data, the claims processing subsystem 110, and the rebate subsystem 120 may be configured to communicate with each other through one or more communications networks, including but not limited to the internet, a LAN (Local Area Network), a WAN (Wide Area Network), a VPN (Virtual Private Network), or any combination thereof.

Although the embodiment illustrated in FIG. 1 shows the claims processing subsystem 110 and the rebate subsystem 120 as separate computers, it should of course be understood that in some embodiments, both of these subsystems may reside and function within a single machine or module that has a single processor. In such embodiments the claims processing subsystem 110 and the rebate subsystem 120 may be part of a single processing system. In yet other embodiments, more than two machines or processors may be used to perform the functions of the claims processing subsystem and the rebate subsystem.

The RPPM system may generate increased rebates, because the combination of up to billions of prescriptions per year, approximately one-half of which may be brand name drugs equivalent to billions of brand name claims, may typically generate a larger market share rebate, compared to market share rebates generated by any one claims processing organization. These rebates may be distributed to employers, pharmacies, employees, consumers (both insured and non-insured), the poor, and the elderly, as well as to charity rebate funds or to drug and disease research organizations such as the cancer foundation.

In the present disclosure, the term rebate shall mean the return of at least some portion of the consideration already paid (or agreed to be paid) for a transaction (e.g. sale of drug), after the consummation of the transaction.

The initial act in implementing the RPPM method may be forming a coalition of pharmacies and their prescription claims. The claims processing subsystem 110 may be connected to the multiple pharmacies through a distributed, interoperable network such as the internet or any other type of communications networks described above. In the embodiment illustrated in FIG. 1, for example, the claims processing subsystem 110 is connected to many pharmacies through a pharmacy data network 112, and is also connected to the switch companies NDC (National Drug Classification) and WebMD Corporation (henceforth “WebMD”), through networks referred to as the NDC network 114 and the WebMD network 116 in FIG. 1.

The data storage subsystem 140 in the RPPM may be used to form a large aggregate or combination of all pharmacy prescription claims. The rationale may be that the more claims processed and stored, the larger the amount of rebates paid, when compared to the rebates paid by many separate combinations of claims processed through different insurance companies. In the case of a specific insurance company, the company would generate rebates based on that specific insurance company's collection of processed claims, which would be much smaller compared to the aggregate of claims processed through the RPPM. The large aggregate of pharmacy claims in the RPPM may thus be used to generate larger market share rebates and performance rebates from the drug manufacturers.

As described earlier, the received claims may be aggregated by the rebate subsystem 120 for the prescriptions made by each manufacturer, i.e. all of the received prescription claims are sorted by manufacturer. The rebate subsystem 120 may be connected (through various networks as described above) to many manufacturers, indicated in FIG. 1 through reference numeral 150. The rebate subsystem 120 may obtain a manufacturer rebate from each manufacturer, based on the aggregated claims for that manufacturer. In some embodiments, the rebate subsystem 120 may be configured to deliver a request to each one of manufacturers 150 for a manufacturer rebate based on the aggregated claims for that manufacturer, and to receive a manufacturer rebate from each manufacturer, in response to the request. The rebate subsystem 120 may allocate a pharmacy rebate to each pharmacy, based on a portion of the manufacturer rebates. In particular, the pharmacy rebate to each pharmacy may be allocated, based on the portion of the manufacturer rebates that is attributable to the claims that are received from the pharmacy. The rebate subsystem 120 may then distribute the pharmacy rebate to each pharmacy.

In some embodiments, the claims processing subsystem 110 may be configured to receive and process the prescription claims from the pharmacies, on behalf of multiple employers. In these embodiments, the rebate subsystem 120 may be further configured to allocate and distribute a rebate to each employer, based on a portion of the manufacturer rebates. In particular, the rebate to each employer may be allocated based on the portion of the manufacturer rebates that is attributable to the claim(s) that are received on behalf of that employer. Each employer may have one or more employees, and at least some of the claims received by the claims processing subsystem 110 may originate from one or more employees, i.e. may have been submitted by, or on behalf of, one or more employees. In these embodiments, the rebate subsystem 120 may be further configured to allocate and distribute a rebate to each of the employees, based on a portion of the manufacturer rebates. In particular, the rebate subsystem 120 may allocate the rebate to each employee, based on the portion of the manufacturer rebates that is attributable to the claims that are submitted by or on behalf of that employee.

In one embodiment (not shown), the rebate subsystem 120 may include a rebate aggregator (not shown) configured to aggregate the claims for the prescriptions made by each manufacturer, and a rebate administrator (not shown). In this embodiment, the rebate administrator may be configured to deliver a request to each manufacturer for a manufacturer rebate based on the aggregated claims for that manufacturer, to receive the manufacturer rebate in response to the request to the manufacturer, and to allocate and distribute a pharmacy rebate to each pharmacy. In this embodiment, the rebate administrator may be configured to allocate and distribute the pharmacy rebate to each pharmacy, based on a portion of the manufacturer rebates. The portion may be the portion of the manufacturer rebates that is attributable to the claims that are received from that pharmacy.

At least some of the claims received by the claims processing subsystem 110 from the pharmacies may originate from one or more parties, i.e. may have been submitted by, or on behalf of, one or more parties. These parties may include, but are not limited to, the following: employees (of one or more employers); consumers (both insured and non-insured); subscribers to a policy; employers; patients; non-prescription insured customers; Medicare recipients; the elderly; and members of organizations.

The rebate subsystem 120 may allocate and distribute a rebate to each of the parties. Each rebate distributed to a party may be computed based on a portion of the manufacturer rebates. In some embodiments, each rebate distributed to a party may be computed based on the portion of the manufacturer rebates that is attributable to the claims that have been submitted by, or on behalf of, the party. The RPPM may distribute the rebates based on the portion of the claim(s) that is attributable to what the respective parties/entities paid. For example, the rebate subsystem 120 may allocate a pharmacy chain's rebates to one sub-category, an employer's rebates to another sub-category, the employees' rebates to another subcategory, a non-insured consumer's rebates (or a rebate for the elderly) to another subcategory, and charity rebates to yet another subcategory. In other words, the rebate subsystem 120 sorts the received claims by sub-groups.

The rebate subsystem 120 may be configured to monitor the dollar amount and percent a party or entity contributes to a specific claim (or claims), i.e. the percentage of the claim (or claims) that the party/entity paid for, as well as the total dollar amount or percentage the individual parties/entities contribute to the total claims stored and processed in the RPPM system. The party or entity may include, but is not limited to, the following: a pharmacy; a pharmacy's headquarters; an employer or other type of company; a wholesaler; a patient; and a consumer.

The rebates distributed to individual consumers (both insured and non-insured), or patients, or to any other type of drug purchasers may include, but are not limited to, one or more of the following: pharmacy coupons; pharmacy credits; pharmacy cash refunds; non-pharmacy store coupons; pharmacy points or miles; airline miles; and club card credits. By paying out the rebates to the individual pharmacies, pharmacy headquarters, employers, etc., and by distributing the rebates to the individual consumers and customers in the various forms listed above, the RPPM system is able to substantially lower prescription costs for all consumers, employees, and employers.

In some embodiments, the allocation and distribution of rebates to the individual parties (consumers, customers, subscribers, patients, etc.) may occur at the pharmacies themselves (either at the individual pharmacies, or at a pharmacy chain headquarters). In these embodiments, each pharmacy (or pharmacy chain headquarters) may have a processing system (not shown) configured to allocate and distribute a rebate to each of the individual parties, based on the portion of the manufacturer rebates that is attributable to the claim(s) that are received on behalf of that party.

The distribution of rebates to the point of sale level in the RPPM system occurs through a flow of the rebates down the pharmacy chain, as a result of which the public (including but not limited to consumers, employees etc.) is able to receive their prescriptions and rebates in many different forms (including but not limited to credits, cash refunds, gift certificates, and free merchandise). The rebates may be monitored by both the rebate recipient and the rebate provider, in a way similar to the monitoring of airline miles. The monitoring may be performed through one or more RPPM websites, for example the “drugbenefitfund.com” website in America. Such websites may keep a running total of rebates that are due to each entity or consumer. The rebates due to each entity or consumer may be monitored through these websites, which may show the total amount of rebates due based on the total claims processed as well as the percentage that is attributable to that entity or consumer.

In one embodiment, the system 100 may further include a reporting subsystem 130 configured to post information about the rebates on a website. For example, the reporting subsystem 130 may be connected to one or more websites via the internet. The reporting subsystem 130 may receive a request at the website from a pharmacy about the pharmacy rebate that is delivered to that pharmacy, and may provide information from the website to that pharmacy about the pharmacy rebate that is delivered to that pharmacy, in response to the request. The reporting subsystem 130 may also receive a request at the website from a party (consumer, employee, employer, etc.) about the rebate that is delivered to that party. The reporting subsystem 130 may and provide, in response to the request, information from the website to that party about the rebate that is delivered to that party. In one embodiment, the reporting subsystem 130 may deliver periodic statements to each of the pharmacies about the pharmacy rebate that is delivered to that pharmacy.

In one embodiment, the rebate subsystem 120 may distribute the pharmacy rebate by electronic transfer of funds, for faster payment and less loss in interest. The rebates may, for example, be distributed and transmitted through an ATM/Debit type transaction. In the case of insured or non-insured consumers, their registered discount or benefits card may be electronically transmitted from their pharmacy to the RPPM network. The resulting quicker payment and reimbursement would result in less interest loss for the pharmacies. Such electronic funds transfer may impact savings quite dramatically.

Pricing of Prescriptions Based on Real Cost of Drug Plus Fee

In another embodiment of the systems and methods described below, prescription costs may-be lowered by replacing an average wholesale pricing method, standard in the industry, with a formula based on the real cost of prescription drugs.

Prescription insurance plans or claims processors, such as PBMs (Prescription Benefit Managers), generally bill employers using the AWP (Average Whole Price) pricing method, which is an industry standard. The AWP method is an escalated pricing method that includes an inherent mark-up in the charges billed to employers and consumers. The AWP may include a very hefty mark-up from the real cost of the drug, and typically ranges between about 30% to about 1000% or higher, compared to the actual acquisition cost that the pharmacy pays to the wholesaler when acquiring a prescription drug, i.e. compared to the real cost of the drug. For convenience, the actual acquisition cost paid by the pharmacy to the wholesaler will hereinafter be referred to as the AC. Typically, the AC is about 10% higher, compared to the actual amount the wholesaler pays the drug company.

In one embodiment of the methods and systems discussed in the present disclosure, the industry standard AWP pricing method, used by current prescription claims processors and other third party groups, is replaced by a formula based on the real cost of the drug (which is the AC or the acquisition cost paid by the pharmacy to the wholesaler), plus fixed fees. For convenience, this formula will hereinafter be referred to as the Cost Plus formula. The Cost Plus formula provides a pricing method for prescription drugs that is based on the real cost of the drug, plus certain fixed fees, instead of marking up the AC in an escalated and arbitrary fashion, as is done when the AWP method is used.

In an embodiment in which an employer has a pharmacy on the premises for employees only, the Cost Plus formula may be given by:
CODS(Cost of Drug Sold)+Fixed Fees=PBC(Prescription Benefit Cost) (1)

In equation (1) above, the term “Cost of Drug Sold” stands for the on-premise pharmacy's real cost for the drug sold. In other words, the is the same as the actual acquisition cost (AC) which is the price paid by the pharmacy to the wholesaler for the drug. The term “Fixed Fees” in equation (1) above may include the following fees: a) a fee for the cost of operating the pharmacy; and b) an RPPM fee. The Prescription Benefit Cost is the total cost to the employee for the prescription benefit. Equation (1) may be equivalently written by spelling out the Fixed Fees term, as follows:
CODS(Cost of Drug Sold)+COOP(Cost of Operating Pharmacy)+RPPM fee=PBC(Prescription Benefit Cost) (1)′

The Cost Plus formula for pricing prescriptions, described above, may be used to decrease prescription benefit costs, by allowing the employer to use a pharmacy on the premises for employees only, then to bill the employee based on the CODS (real cost of drug sold). The Cost Plus formula reduces prescription benefit costs for employers (e.g. corporations), by eliminating the need for an insurance plan such as a PBM, and/or a retail pharmacy, depending on the corporation's or employer's facilities and whether or not they have or want a pharmacy on the premises.

Alternatively, in a situation in which the pharmacy serves not only the employees of a specific employer, but also the general public, the Cost Plus formula may be given as follows:
CODS(Cost of Drug Sold)−(Retail Net Revenue+Copay+Rebates)+COOP (Cost of Operating Pharmacy)+RPPM fee=PBC(Prescription Benefit Cost)with retail net revenue (2)

As seen in Equation (2) above, in this case the CODS (real cost of drug) is reduced by a term that is a sum of: retail net revenue, copay, and rebates. For convenience, the sum of retail net revenue, copy, and rebates may be hereinafter referred to as a term called “Prescription Benefit Cost Reducer.” The difference between CODS and the Prescription Benefit Cost Reducer may be viewed as a net cost of the drugs, which may be given by: Cost of Drug Sold less retail net revenue and less copay and less rebates. Equation (2) may thus be viewed as stating that the net cost of drugs plus fixed fees (cost of operating pharmacy plus RPPM fee) is the PBC with retail net revenue.

In the Cost Plus formula as provided in equation (2), the prescription benefit cost is further reduced (from a sum of the real or actual cost of drugs plus fixed fees) by the retail net revenue of the pharmacy, the copay paid by the customer of the pharmacy (who is also the purchaser of the prescription benefits), and the rebates distributed to the customer by the pharmacy.

The Cost Plus formula as provided in equation (2) reduces prescription benefit costs for employers (e.g. corporations), by eliminating the need for an insurance plan such as PBMs. By eliminating the PBM, the employer is in control of the management of the billings, and is charged much lower fees, compared to what the PBMs would have charged the employer. The employer may hire an accountant who may manage the prescription benefits using the Cost Plus formula, and who may provide the employer with more control over issues such as prescriptions billing fraud and drug diversion.

Employers and/or pharmacies that use the Cost Plus formulas (provided in equations (1), (1)′, and (2) above) may be viewed as acting as their own PBM, since the Cost Plus formulas discussed above eliminate the need for PBMs. Referring back to the system 100 illustrated in FIG. 1, the claims processing subsystem may include an operating system configured to allow the pharmacies and/or employers to act as their own PBM, while at the same time allowing the pharmacies to continue to bill via traditional PBMs, when needed or desired. In other words, while the RPPM system unifies pharmacies and their claims, is still provides options for current prescription benefit providers (i.e. PBMs) to be included in the transmission and processing of prescription claims.

Typically, PBMs bill employers, and pay pharmacies using a formula based PBMs bill employers using the following formulas:

for brand name drugs and some of the more expensive generic drugs, AWP minus from about 14% to about 25% is charged by PBMs;

for generic drugs, AWP minus about 30% is charged by the PBMs;

for very inexpensive generics, PBMs charge the maximum allowable cost of ingredients (“MAC”), times a metric quantity.

Depending on the contract with the individual pharmacies, PBMs may use different formulas to pay pharmacies. For brand name drug, for example, the PBMs may charge the AWP times a metric quantity, minus 15%, plus a dispensing fee. For generic drugs, the PBMs may pay pharmacies an amount given by the MAC (maximum allowable cost of ingredients), times a metric quantity, plus a dispensing fee.

The RPPM system 100 (described in FIG. 1) may be analogous to a single large PBM throughout the US, that uses a prescriptions pricing method that is based on the real cost of the drug, and that gives rebates back to the consumers. The RPPM would achieve maximum capability by aggregating most of the US PBM networks and/or pharmacies, their prescription claims, and the employers originating the claims.

The RPPM system 100 may implement a pricing method based on Cost Plus, using one of the formulas explained above, depending on the particular situation. Alternatively, the RPPM system 100 may implement a pricing method based on subtracting a percentage from the AWP to make the resulting prescription price the same as if Cost Plus had been used. In other words, the RPPM system 100 may reduce prescription costs by using the formula
AWP−X %, (3)
where X is chosen so that the resulting price is equal to the price that would have been obtained using Cost Plus. A certain percentage is subtracted from the heavily marked-up AWP, where the percentage is typically much larger than the 14% to 15% used by PBMs, and in particular is large enough so that the resulting price is equal to the price that would result from a Cost Plus pricing method.

In embodiments in which the RPPM system 100 implements prescription pricing methods based on Cost Plus (equations (1), (1)′, and (2)) and/or “AWP−X %” (equation (3)), the RPPM system 100 may include one or more subsystems and/or processors that are programmed and configured to compute prescription prices using the formulas provided above (equations (1), and/or (1)′, and/or (2), and/or (3)). In these embodiments, the RPPM system 100 may include both computer software and hardware necessary for performing such computations.

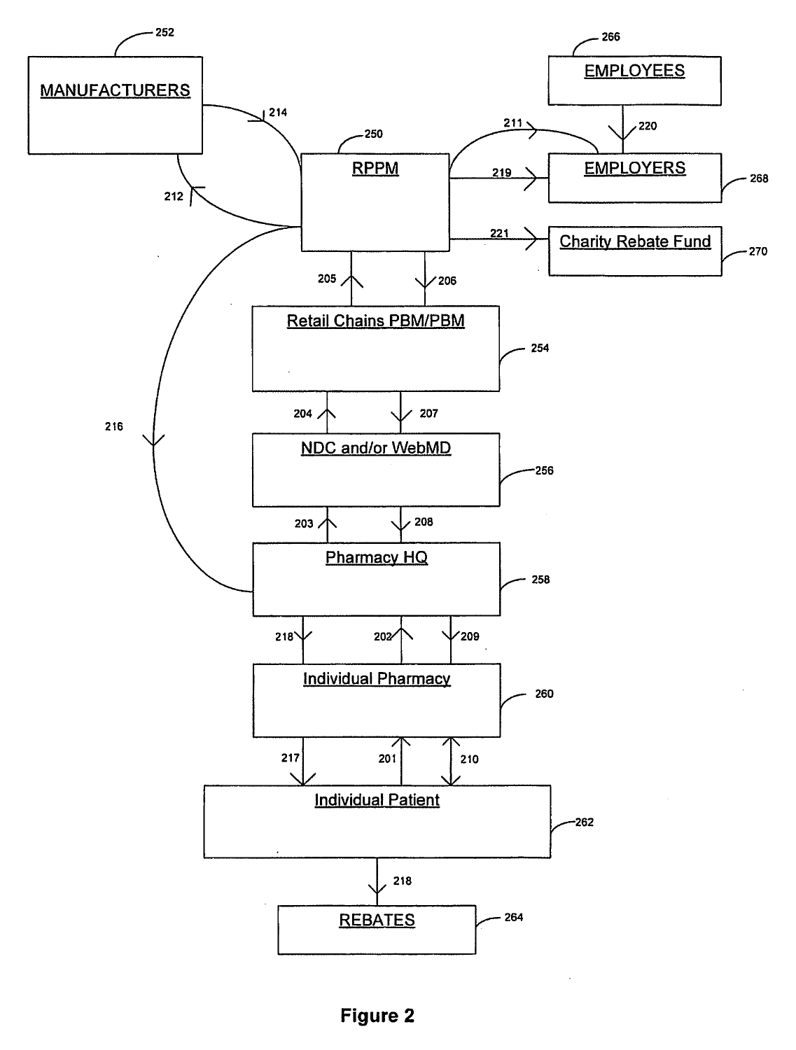

FIG. 2 is a conceptual diagram illustrating a flow of operations that may occur between different entities, in one embodiment of methods and systems in which prescription costs are lowered by aggregating claims and obtaining manufacturer rebates, and by using the Cost Plus pricing method described above.

In the embodiment illustrated in FIG. 2, an RPPM 250 (which in some cases may be an Employer Benefit Fund) allocates the rebates and bills the employer(s) 268, but gives the option to allocate directly via the NDC (and/or WebMD) 256, or directly to the pharmacy headquarters 258. A retail chain PBM 254, or any PBM, may carry out the adjudication of prescription claims, using the Cost Plus pricing method described above, or using AWP−X %, where X is chosen so that the resulting price is the same as the price obtained using Cost Plus. The retail chain PBM 254 then submits the claim to the RPPM network, so that rebate allocation and distribution can be carried out as described in conjunction with FIG. 1.

In initial act 201, in the flow of operations conceptually illustrated in FIG. 2A, an individual patient 262 may bring his prescription into an individual pharmacy 260. The patient 262 may include, but is not limited to, any one of the following: a consumer (either insured or non-insured); a subscription policy holder; an employee or dependent thereof; a non-card holder. In act 202, the pharmacy 260 may transmit the claim through the mainframe at the pharmacy headquarters 258.

In act 203, the claim may pass through a switch company, which may either be the NDC or the WebMD. In act 204, the NDC or the WebMD may route the claim to the designated PBM 254. In act 205, the patient's claim is submitted to the data storage subsystem in the RPPM 250, where claims are aggregated for rebate purposes, and prescription pricing under the Cost Plus method or the AWP-X % method occurs. In act 206, the RPPM 254 may verify eligibility of the transmitted claim for the RPPM aggregation method, and upon satisfactory verification, may request the PBM 254 to report to the pharmacy 260 that the patient is eligible. The RPPM 254 may also read price tables from the PBM transmissions and the pharmacy transmissions. The RPPM 254 may also compute and report any co-pays, rebates, fees, and other formularies that may be applicable to the particular claim from the patient.

In act 207, the PBM 254 may transmit to the pharmacy 258 through the NDC or the WebMD 256 the approval for the patient 262 to receive the drug from the pharmacy 260 for the suggested co-pay. In act 208, the NDC/WebMD may relay this request back to the pharmacy headquarters 258 that sent the original request. In act 209, the claim passes through the pharmacy headquarters 258 to the actual pharmacy 260. In act 210, the claim is logged onto the patient profile of the individual patient 262. A label may be generated, including information such as: the total reimbursement due to the pharmacy; the pharmacy's actual acquisition cost of the drug (AC or equivalently CODS); the RPPM/EBF fee; the patient's co-pay; and the rebate miles and/or points due to the patient and/or the patient's employer, and to the pharmacy, based on the portion of the aggregated claims that is attributable to the claim submitted by the pharmacy, the employer, and the patient, respectively.

In act 211, the RPPM 250 bills the employer 268, using Cost Plus or AWP−X %. In act 212, a rebate subsystem in the RPPM 250 aggregates the claims by manufacturer, and requests are sent to the manufacturers for manufacturer rebates. In act 214, the manufacturers pays the manufacturer rebates to the RPPM 250. In act 216, the manufacturer rebates are allocated to the pertinent parties, then distributed by the rebate subsystem in the RPPM 250 to the pharmacy headquarters 256 and the individual pharmacy 260. In act 217, the rebates received by the individual pharmacy 260 are allocated to each individual patient based on the portion attributable to the claim(s) submitted by the individual patient. In act 218, the rebates are distributed in various forms, including but not limited to: a prescription credit; a store or pharmacy coupon; as store club card (e.g. a VONS card that can be used nationally), and a cash refund.

In act 219, the manufacturer rebates (received from the manufacturers) are allocated to employers, based on the percentage attributable to what the employer paid for that claim. Finally, in act 220 the employers 268 allocate and distribute the rebates to the employees 266, in various forms including but not limited to: increased wages; paid vacations and/or days off; free vacation packages and promotions; free store merchandise; lower co-pays and/or deductibles; and airline tickets. Finally, in act 221, the rebates are distributed to a Charity Rebate Fund.

As can be seen from FIG. 2, the RPPM system and method allows individual pharmacies and the pharmacy headquarters to control the distribution of drugs, instead of PBMs and other the claims processing insurance companies.

FIG. 2 is a conceptual diagram of one illustrative example, only, and in other embodiments of methods and systems in which prescription costs are lowered by aggregating claims, variations may occur in the flow of operations between different entities. For example, the NDC and the WebMD may together form by themselves the RPPM network. At present, the NDC together with the WebMD would constitute a larger market share, compared to any one PBM, and would be able to form a consolidated market share database having a maximum capacity. While NDC and WebMD traditionally have been a hub or center for prescription claims, they have not been aggregated so far for the purpose of USA rebates. In this example, the traditional PBMs would adjudicate the prescription claims (using AWP−X % where X is chosen so that the resulting price is equal to the price that would result from a Cost Plus pricing method), while the NDC and the WebMD would carry out rebate allocation.

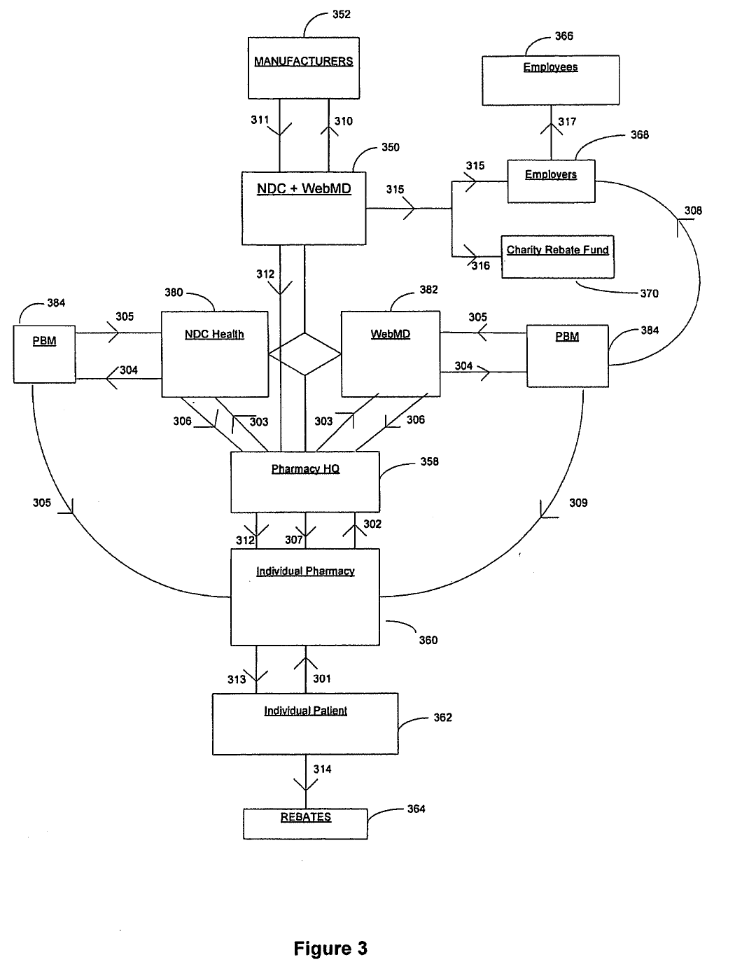

FIG. 3 illustrates a conceptual diagram illustrating a flow of operations that may occur between different entities, in an embodiment in which the NDC and the WebMD together form the RPPM system and network itself. In the embodiment illustrated in FIG. 3, the patient 362 may bring his prescription claim into an individual pharmacy 360, in initial act 301. The prescription claim of the patient 362 may be submitted by, or on behalf of, the patient. The pharmacy 360 may transmit the claim through the mainframe at the pharmacy HQ (headquarters) 358, in act 302. In act 304, the NDC 380 or the WebMD 382 routes the claim to the designated PBM 384 for adjudication of the claim.

In act 305, the PBM 384 transmits, through the NDC 380 or the WebMD 382, the approval for the patient 362 to receive the drug from the pharmacy 360 for the suggested co-pay. In act 306, the NDC or the WebMD relays this request back to the pharmacy headquarters 358 that sent the original request. In act 307, the claim passes through the pharmacy headquarters 358 to the individual pharmacy 360. The claim is then logged onto the patient profile of the individual patient 262. A label may be generated, including information such as the total reimbursement due to the pharmacy, the pharmacy's actual acquisition cost of the drug (AC or equivalently CODS); the RPPM/EBF fee; the patient's co-pay; and the rebate miles and/or points due to the patient and/or the patient's employer, and to the pharmacy, based on the portion of the aggregated claims that is attributable to the respective claim(s) submitted by the pharmacy, the employer, and the patient.

In act 308, the PBM 384 bills the employer 268, using Cost Plus or AWP-X %. (Note that in the embodiment illustrated in FIG. 2A, the RPPM 250 billed the employer). In act 309, the PBM 384 pays the pharmacy HQ 358 and the individual pharmacy 360 the amount due that was computed using the Cost Plus method. In act 310, the RPPM (i.e. the NDC/WebMD 350) claims are aggregated by manufacturer, and requests are sent to the manufacturers for manufacturer rebates. In act 311, the manufacturers transfers the manufacturer rebates to the RPPM system and account. In act 312, the RPPM 350 allocates the manufacturer rebates to the pertinent parties, then distributed to the pharmacy headquarters 358 and the individual pharmacy 360. In act 313, the rebates are allocated to each individual patient based on the portion attributable to the claim(s) submitted by the individual patient. In act 314, the rebates are distributed in various forms, as explained above in connection with FIG. 2A.

In act 315, the manufacturer rebates are allocated to employers, based on the percentage attributable to what the employer paid for that claim. In act 316, the rebates are allocated to a charity fund. Finally, in act 317 the employers 368 allocate and distribute the rebates to the employees 366, in various forms discussed above in connection with FIG. 2.

Incorporation of Projected Rebates into the Wholesale Acquisition Cost

In a further embodiment of the systems and method described below, prescription costs may also be lowered by estimating the rebates that are expected to be paid by manufacturers to PBMs (prescription benefit managers), then incorporating the projected rebates into the wholesale acquisition cost of the drugs.

In this embodiment, the RPPM System 100 (shown in FIG. 1) estimates the rebates that will be paid by manufacturers to prescription benefit providers (PBMs), in order to eliminate these manufacturer rebates and incorporating them directly into the industry's current WAC (Wholesale Acquisition Cost) price. This is an alternative way of allowing the pharmacies, wholesalers, employers, consumers, and other parties to benefit from the increased manufacturer rebates that result from the aggregation of prescription claims made possible by the RPPM system 100. The amount of discount applied to the WAC typically varies for each entity (e.g. individual pharmacy or pharmacy headquarters), and is influenced by the amount of drug purchases by the entity.

In this embodiment, the WAC (wholesale acquisition cost) of all manufacturer drugs are lowered, by projecting the amount of rebates that will be incorporated into the pharmacy's or wholesaler's drug cost. For brand name drugs, the total dollar amount of rebates that will be incorporated into each individual drug cost may be determined by aggregating the total number of prescriptions from a specific manufacturer, times the average brand prescription price (which in many cases may range from about $100 to about $110), times the average claims processing rebates that PBMs typically pay (which in many cases may range from about 10% to about 15%). The resulting sum will hereinafter be referred to as a Projected Rebate Sum (PRS).

The pricing system and method based on PRS (Projected Rebate Sum), described above, may allow manufacturers to reduce drug cost overall for wholesalers and pharmacies, reducing the drug cost by an amount attributable to the number of drugs or claims that an entity purchased or processed. In the PRS method, the individual drug cost for each entity may vary, based on the amount of claims processed for each entity. For example, some pharmacies that have a larger market share may have lower costs (i.e. lower WAC) than other pharmacies that have a smaller market share.

The PRS pricing method may provide an incentive for entities such as state or local government offices, or even the federal government, to buy drugs in bulk using the RPPM system and the PRS pricing method described above. By using these methods, drug wholesalers and national pharmacy chains that buy and process billions of prescriptions would incur much lower drug costs compared to what they currently incur. than they are today (WAC-4-6%). Even wholesalers' bulk discounts would increase.

In an embodiment of the RPPM system in which the PRS method is used, the RPPM system may include a PRS (Projected Rebate Sum) subsystem (not shown). The PRS subsystem may be configured to aggregate the drug sales of a drug manufacturer, then multiply by the current assigned AWP (Average Wholesale Price) price, thus generating a total average wholesale price for all of the manufacturer's drug sales. For convenience, the total sum of all of a manufacturer's drug (or product) sales will hereinafter be represented by the acronym MPS-sum, and the total average wholesale price for the MPS-sum will hereinafter be represented by the acronym AWP-sum. The PRS subsystem may further be configured to multiply the MPS-sum by 15%, to obtain the PRS (Projected Rebate Sum).

The PRS method can thus be represented by the following formula:
PRS(Projected Rebate Sum)=(MPS-sum)×(AWP sum)×15%, (4)
where MPS-sum stands for the total sum of all of a manufacturer's product sales, and AWP-sum stands for the total average wholesale price for the MPS-sum For convenience, the difference between the sum of the assigned wholesale acquisition cost for a manufacturer, and the PRS for that manufacturer, may be referred to as the Incorporated Rebate Cost (IRC). Also for convenience, the difference between the WAC (wholesale acquisition cost), and a sum of PRS plus bulk buying rebates, will be referred to as the Rebate Coalition Factor (RCF).

The PRS subsystem may also be placed in any entity, not just in the RPPM. For example, drug manufacturers may have a PRS subsystem, which would allow the manufacturers to project how much would be paid in market share rebates and formulary rebates, with respect to the number of prescription claims that have been processed.

An alternative formulation of the PRS (Projected Rebate Sum) is the total amount of manufacturer claims times the Average wholesale Price (AWP), minus 10%-15% rebates. When viewed in this way, the PRS pricing method can be seen as lowering drug costs by eliminating rebates for insurance companies, such rebates being undeserved because not based on the amount of purchase of the pertinent drug. The PRS pricing method can be seen as rewarding the parties or entities that actually purchase the drugs, including but not limited to pharmacies, employers, wholesalers and consumers.

The PRS subsystem and pricing method allow manufacturers to avoid paying market share and/or formulary rebates, by incorporating these rebates into the current WAC (Wholesale Acquisition Cost) for each drug during pre-sale. The PRS subsystem allows manufacturers to avoid paying rebates to claims processing companies or insurance companies, such as the PBMs.

By using the PRS (Projected Rebate Sum) subsystem, drug companies and manufacturers may be able to incorporate claims processing rebates (which typically had been paid out by the manufacturers to the PBMs) and other fees, as well large bulk discounts resulting from bulk purchases by pharmacies and/or employers, directly into the wholesale acquisition cost (WAC) of the drug. As a result, drug costs would be lowered between about 25% and about 50%, depending what how many pharmacies and how many corporations/employers are members of the RPPM system and network.

Individual Drug Benefit Plans Implemented by Individual Pharmacies/Employers

In yet another embodiment of the systems and methods described below, prescription costs may be lowered through individual drug benefit plans implemented by individual pharmacies and/or employers, in competition with outside benefit plans. In this embodiment, individual pharmacies and/or employers are allowed to implement their own “in-house drug benefit programs,” in competition with the outside benefit plans.

In this embodiment, pharmacy chains, or individual pharmacies, which usually use an outside claims processing company (typically a PBM) may transmit and process claims within their own company network, to avoid un-necessary processing fees, while increasing their revenue and bottom line profits. They may incorporate an in-house RPPM database, or use a pre-existing PBM system, to process the prescription claims for their own employees processing, and to collectively aggregate their in-house claim. They may connect and transmit these in-house claims to a central RPPM network or node within which multiple pharmacies and pharmacy chains are connected, thereby allowing each pharmacy or pharmacy chain headquarters to collectively maximize their market share, performance, or other formulary rebates.

In this embodiment, the in-house drug benefit plans described above may also have the option of catering to the claims processing needs of employees of other pharmacies and/or pharmacy chains, for an additional fee. As a simple example, the Safeway In-House Drug Benefit Program may provide for it's own employees at all Safeway's for an extremely low co-pay. If a Safeway employee lives far away from a Safeway Company Store, however, then that employee may have the option of using an Albertson's Pharmacy to process his prescription claims, by paying an additional fee. This option makes is possible for each individual pharmacy and/or pharmacy chain and/or employer to compete with outside prescription claims providers, by providing incentives to their employees to process their prescription claims in-house, rather than seeking outside prescription claims providers, which may be a competitor of the in-house drug benefit plans.

When pharmacies and/or pharmacy headquarters act as their own PBM for employers using their own in-house drug benefit program (primarily designed for their own employees), as described above, they may be able to control the distribution of drugs. They may also be able to generate and receive larger market share rebates from a centralized RPPM node that connects to many in-house pharmacies or RPPM node-subsystems of many entities. This would result in lower drug prices overall, for the USA.

In this embodiment, the RPPM system may review each prescription claim to determine whether or not an employee is seeking an outside prescription claims provider (for example a competitor of the employer's in-house pharmacy provider), and to charge the employee a higher co-pay when employees are seeking an outside prescription claims provider rather than the in-house pharmacy provider.

The RPPM system and network, or the NDC or/and WebMD's networks and systems that are performing as the RPPM (see FIG. 3), may route prescription claims based on an incoming request from the pharmacies, using a specific carrier code and plan name, for the purpose of determining if the claim seeks an out-sourced prescription claims provider (and thus a higher co-pay should be charged), or if the claim is in-house, and identifying the proper subtype for each prescription claim. The individual prescription claim submissions may be categorized by carrier code subtype and plan name subtype. The subtypes may include (but are not limited to): 1) the preferred pharmacy provider for that patient; 2) the non-preferred pharmacy provider; and 3) a pre-existing PBM for employers that are not self-insured or not insured by the RPPM.

In this embodiment, the RPPM system 100 (shown in FIG. 1) may include another subsystem (not shown), which may be referred to as a Claims Identification Subsystem (CIS). The CIS (Claims Identification Subsystem) may be configured to allow transmission of claims (from the employees) to the central RPPM system (or to the NDC and/or WebMD that is performing as the RPPM). The CIS may be further configured to divide up the claims into various subtypes or categories, for the purpose of determining the employees co-pay and plan guidelines. For example, the CIS may be configured to determine whether the employee chose to go through an in-house plan, or to a competitor's plan.

Each pharmacy and company may individually and independently compete to provide and contract with other employers/employees. This may allow the drug manufacturers to keep their rebate scheme, while rewarding the proper drug buyers. This may motivate employees to use their own employers drug benefit plan, while still allowing them to use another company's pharmacy and benefit plan for an additional fee, if more convenient.

In this embodiment, each pharmacy is allowed to be a part of a central RPPM Node that connects most pharmacies through their respective in-house RPPM nodes. In this embodiment, drug purchase discounts may increase, for the following reason: the more prescriptions and drugs a given pharmacy or pharmacy headquarters purchases, the greater the discounts for these purchases. The more a person buys, the more discounts he receives. The more prescription claims an employer is able to influence its employees to process for drugs made by a specific manufacturer, the more rebates the employer receives.

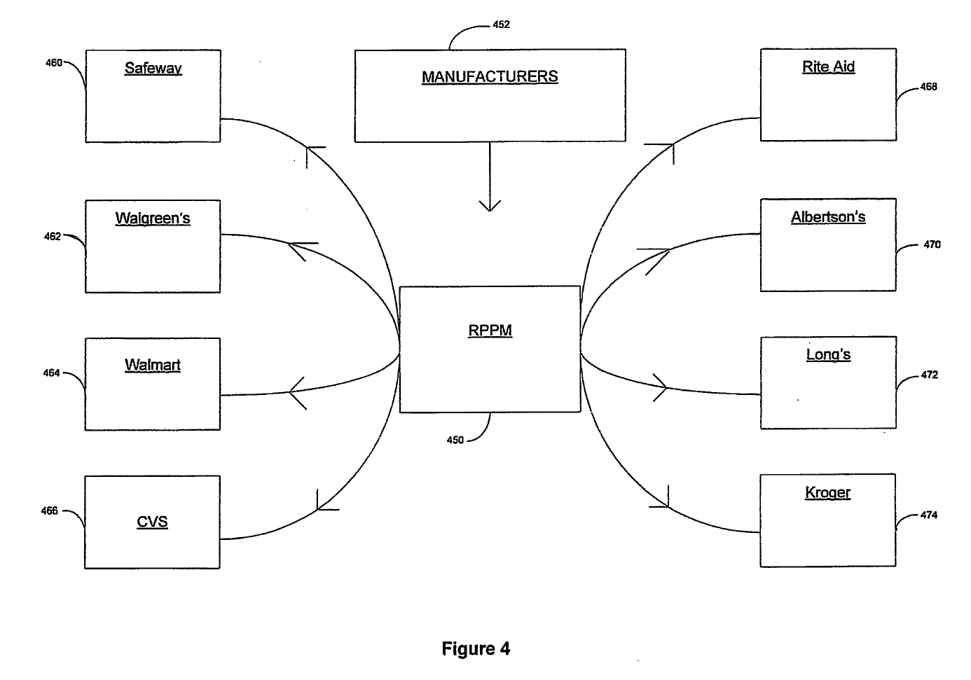

FIG. 4 is a conceptual diagram illustrating a system and method for lowering prescription costs through drug benefit plans implemented by individual pharmacies and/or employers in competition with outside benefit plans. As seen in FIG. 4, the RPPM (which in some embodiments, such as the embodiment illustrated in FIG. 3, may be formed by the NDC together with the WebMD) 450 may be connected to multiple in-house drug benefit plans, through respective in-house RPPM database. In FIG. 4, eight in-house plans are illustrated (Safeway plan 460, Walgreen's plan 462, Walmart plan 464, CVS plan 466, Rite Aid plan 468, Albertson's plan 470, Long's plan 472, and Kroger plan 474), although of course the examples shown are for illustrative purposes only, and many other in-house drug benefit plans may be connected to the RPPM 452.

In the illustrated embodiment, individual pharmacies and their corporate headquarters act as an individual claims processor, influencing and controlling the distribution of drugs by offering the patient rebate incentives, and allowing the physician to have a final say and approval in choosing a prescription drug. Allowing the physician to choose may be a more rational approach, compared to forcing the physician to prescribe a drug just so that some PBM can receive a higher (and undeserved) rebate. Although each of the in-house drug benefit programs shown in FIG. 4 (460-474) competes with each other for employer contracts, they are all part of the central RPPM network 450, and may all provide for each other and each of their contracted employers, with the understanding that an additional co-pay will be charged for going to an outside company's drug benefit plan.

The embodiment illustrated in FIG. 4 allows pharmacies and employers to unify their claims for the purpose of larger market share rebates, while still allowing individual pharmacies (and/or pharmacy HQs) to compete and act as their own drug benefit plan. This allows drug manufacturers to continue to use rebates to promote their products.

The RPPM method described above may be applied in a variety of ways, depending on the circumstances and/or political strengths of the entities involved. The different applications of the RPPM system and method all allow the entities that purchase drugs to pay less, through RPPM computed rebates, as well as through the incorporation of rebates into wholesale acquisition costs. The end result may be greater consumer satisfaction and employee satisfaction, as well as lower overall drug costs incurred by the wholesalers, the employers, and the pharmacies.

In-Room/In-Home Expedited Delivery of Prescriptions

In yet another embodiment of the present disclosure, prescription requests may be processed through a prescription claims processing center that implements methods and systems (described below) for expedited processing and delivery of the prescriptions. Such expedited delivery includes same day delivery of the prescription to the customer's home or to a hotel room where the customer is staying.

In overview, prescription requests may be received at the prescription claims processing center. The prescription requests may be for customers who want prescriptions to be filled and to be delivered to them. Each prescription request may include information about the geographic location of the customer. Based on the geographic location information, the prescription claims processing center may select a prescription service provider, from a list or database of known prescription service providers, for fulfillment of the prescription. The known prescription service providers may include pharmacies, medical institutions (hospitals, medical centers, physician's office, etc.), or medical professionals. In one embodiment, the prescription service provider that is located nearest to the geographical location of the customer may be selected by the prescription claims processing center for fulfillment of the prescription.

The prescription claims processing center may then route the prescription request to the selected prescription service provider for fulfillment of the prescription. The selected prescription service provider may be a pharmacy, a medical institution, or a medical professional (e.g. a physician). In some embodiments, the prescription requests may be for prescriptions that had previously been ordered for the customer by a physician, and had previously been filled for the customer by a pharmacy. In these cases, the prescription claims processing center may transmit the received prescription request to the pharmacy that had previously filled the prescription, which in turn may transmit the prescription request (together with records relating to the previously filled prescription) to the selected prescription service provider (closest geographically to the customer) for fulfillment of the prescription. In other embodiments, the prescription request may be for a new prescription drug that the customer has never taken before, and for which the customer needs a written order from a medical professional. In these cases, the prescription request may be transmitted to a medical professional (e.g., a medical professional who happens to be on call at the time of the request at a medical institution that is nearest to the customer), so that the medical professional can write an order for the requested prescription drug and transmit the written order to a providing pharmacy for fulfillment of the prescription.

When the selected prescription service provider receives the prescription request, the selected prescription service provider may fulfill the prescription. The prescription claims processing center may then arrange for the filled prescription to be delivered to the geographical location of the customer within a desired time frame. Alternatively, the selected prescription service provider may offer their own delivery service that picks up the filled prescription and delivers it to the customer's geographic location within the desired time frame. In both cases, the desired time frame may include expedited same-day delivery on the same day the request was submitted.

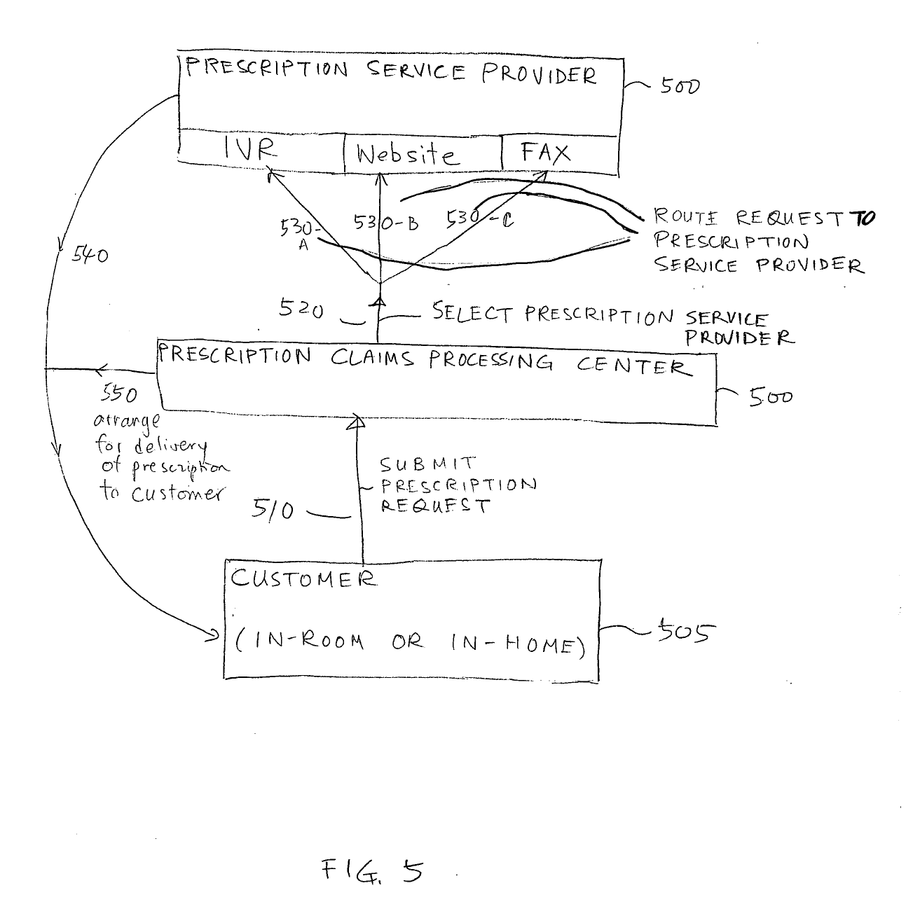

FIG. 5 conceptually illustrates an overview of a flow of operations that may occur, in one embodiment of a system and method for providing expedited processing and delivery of prescription services. In initial act 510, a request for a prescription may be submitted to a centralized prescription claims processing center 500. The prescription request may be a request for a prescription drug (i.e. a drug that needs a prescription from a medical professional). Alternatively, the prescription request may be a request for a written prescription order for a prescription drug.

The prescription claims processing center 500 may be a 24 hour service center that allows customers to order their prescriptions at any time, from the convenience of their homes and/or hotel rooms and/or other locations convenient for the customer. The prescription claims processing center 500 may be the RPPM system 100 described above. In this case, the prescription claims processing center 500 may distribute claims processing rebates to customers and patients, who are the actual drug buyers, in the manner described earlier when describing the RPPM 100.

Alternatively, the prescription claims processing center 500 may be a traditional PBM that does not distribute claims processing rebates to pharmacies and other consumers of the prescriptions, unlike the RPPM system described above. Alternatively, the prescription claims processing center 500 may be switch companies such as the NDC and the WebMD described above. Alternatively, the prescription claims processing center 500 may be an online, virtual pharmacy accessible through an Internet website.

The prescription request includes information about the geographic location of the customer from which the customer submits his request. For example, the customer 505 may be a guest at a commercial lodging facility, such as a hotel, motel, inn, condominium, time share unit, or resort center. In this case, the geographic location of the customer would be a room in the commercial lodging facility at which the customer is staying at the time of his request, and the prescription request would include geographic location information such as the zip code, city, state, telephone area code, telephone number, and street address of the commercial lodging facility.

In the embodiment in which the customer is a hotel guest staying in a hotel room, the customer may submit his request through an in-room TV, or by an in-room concierge service menu, both of which may offer interactive access by the guests of the hotel. Alternatively, the customer may fill out the paperwork for his prescription request, then forward the prescription request to the concierge desk in the hotel. The concierge may then submit the prescription request to the prescription service processing center 500.

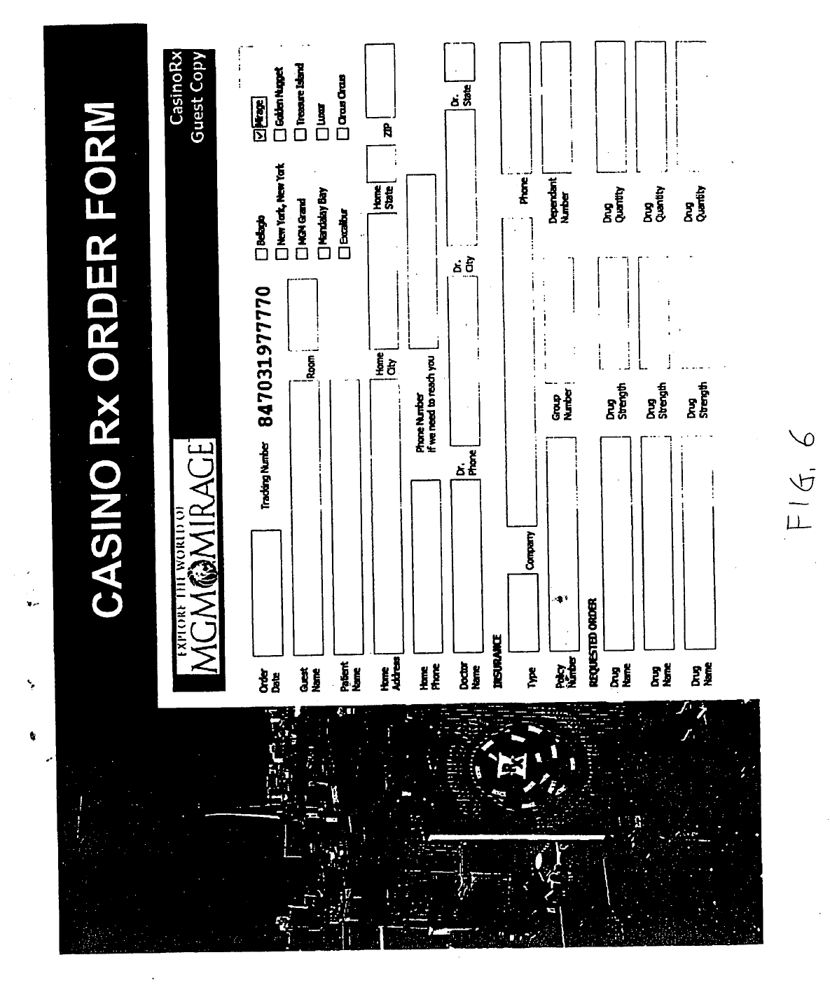

FIG. 6 illustrates an exemplary order-screen that may appear on an internal cable network of a TV in a guest's room, to allow the guest to submit an order for in-room expedited delivery of ordered prescriptions. The in-room TV may provide pull-down menus for the customer, allowing the customer to choose the type of prescription drug requested. As seen in FIG. 6, information entered by the guest in the order form includes geographical information about the customer, such as his home street address, city, state, and zip code. Other type of information requested from the customer may include, but are not limited to: the name, phone number, and address of the customer's doctor; name, strength, and quantity of requested drug; and insurance information.

Referring back to FIG. 5, the customer 505 may submit his prescription request from his home, rather than from a hotel room. In this case, the geographic location information in the prescription request would be the home address of the customer 505, including the zip code, city, state, and street address of the customer's home, as well as the home phone number and home area code of the customer 505.

The prescription request may be submitted to the prescription claims processing center 500 in a number of ways. As one example, the prescription may be submitted by telephone to reach the prescription claims processing center 500. The customer may dial a telephone number of the prescription claims processing center 500 which may be toll-free, and which may be publicly advertised, e.g. through a TV ad, listed on a brochure, or listed in an in-room menu provided to a hotel guest.

In this case, the prescription request may be received by a service representative of the prescription claims processing center 500. The service representative may ask for information from the patient, such as: the customer's full name, address, city and state, zip code, birth date, immediate contact phone number; the name and contact information of the customer's doctor; the prescription service or drug being requested; one or more previous pharmacies, if any, where the prescription being requested may be located; any drug allergies; and insurance information. Depending on the information received from the patient, the service representative may call the patient's doctor for approval of the prescription. Alternatively, the service representative may ask the doctor to transfer the prescription request to another prescription service provider, e.g. a prescription service provider which may be closer geographically to the customer.

Rather than submitting the prescription request by phone, the request may be transmitted electronically to the prescription claims processing center 500, e.g. by faxing the request, or e-mailing the request, or by electronically scanning the request to a remote scanner connected to the prescription claims processing center 500, or by transmitting the request through a cable server. As another example, the request may be transmitted online to an Internet website of the prescription claims processing center 500. As yet another example, the request may be transmitted from a cable TV through a cable server.

The prescription request may be transmitted using a number of different devices, These devices may include, but are not limited to: a telephone; a cellular phone; a wireless handheld unit (for example a Blackberry, a Trio, and a Sidekick); a laptop computer; a PC; an ATM; and a remote control unit of a TV offering a cable channel through which the prescription request can be submitted.

After receiving the prescription request, the prescription claims processing center 500 processes the received request in act 520, by selecting or designating a providing pharmacy or other prescription service provider 590, which operates at a known geographic location. The prescription claims processing center 500 may select the prescription service provider 590 from a plurality of prescription service providers, based on the geographic location information about the customer that was received with the prescription request.

The plurality of prescription service providers may have known geographic locations, which may be stored at a database, and at least some of which may be different geographic locations. Typically, the plurality of prescription service providers may be located at different geographic locations throughout the U.S.

In one embodiment, the service representative of the prescription claims processing center 500 may provide private phone consultation services to the customer who called the prescription claims processing center 500 to submit his/her request. In this embodiment, a patient consultation line may be installed in the pick up counters of one or more of the pharmacies 590. In this way, the customer may be able to receive private HIPPA (Health Insurance Portability and Accountability Act) consultation via phone from the service representative of the prescription claims processing center 500. This may minimize fines and non-compliance penalty charges that pharmacies may risk having to pay, because of inadvertent failure to comply with applicable state consultation laws. This may also provide back up for pharmacists who may be short staffed, and may allow pharmacists to address more immediate patient needs, such as checking and filling their prescriptions.

In one exemplary embodiment, the prescription claims processing center 500 may select the prescription service provider 590 by using e.g. the address zip code or telephone area code of the customer's geographic location, to identify the prescription service provider 590 that is nearest to the geographic location of the customer 505. In this embodiment, the prescription claims processing center 500 may include a processing system configured to store information about the known geographic locations of the plurality of prescription service providers in a database, and to retrieve such information if/when necessary.

The processing system may also be configured to compare the geographic location of the customer (information about which was included in the request received from the customer 505) with the known geographic locations of the plurality of prescription service providers, so as to identify a prescription service provider that is nearest to the geographic location of the customer. For example, the processing system may determine which one of the plurality of prescription service providers is nearest to the geographic location of the customer 505, by comparing information such as the zip code, city name, state name, and telephone area code of the known geographic locations stored in the database, with corresponding information about the customer's geographic location.

The processing system in the prescription claims processing center 500 may receive multiple requests for prescriptions, each request including information such as a zip code, a city name, a state name, an IP address, and a telephone area code of the geographic location of the customer who submitted the request. The processing system may aggregate the received requests for at least one of the zip code, the city name, the state name, the IP address, and the telephone area code of each customer, and may store the multiple requests including the geographic location information in a database.

The prescription claims processing center 500 may then route the received request to the selected prescription service provider 590 for fulfillment of the prescription by the prescription service provider 590, in acts 530-A, 530-B, and 530-C. These acts illustrate three examples, out of the many different ways in which the prescription claims processing center 500 may route the request to the selected prescription service provider 590. In act 530-A, the prescription claims processing center 500 routes the prescription request to an IVR (interactive voice response system) of the selected prescription service provider 590. In act 530-B the prescription claims processing center 500 routes the prescription request online to a website of the selected prescription service provider 590. In act 530-C, the prescription claims processing center 500 routes the prescription request by faxing the request to the selected prescription service provider 590.

Although not illustrated in FIG. 5, other methods may also be used to route the prescription request to the selected pharmacy 590. For example, the request may be scanned and e-mailed to the selected pharmacy 590, or may be scanned into a scan receiver located in the selected pharmacy 590.

In one embodiment, the prescription request may be transmitted to a medical professional, such as a doctor or a physician. As explained earlier, the prescription claims processing center 500, and/or the selected prescription service provider 590 (i.e. the selected pharmacy) may transmit the prescription request to the medical professional. In one embodiment, the medical professional may be selected from a plurality of medical professionals, based on the geographic location of the customer. In one embodiment, the medical professional who happens to be on call at the time of the request may be paged, or otherwise notified about the prescription request from the customer. The medical professional may also receive information about the pharmacy that is selected for fulfillment of the prescription.

The prescription request may be transmitted to the medical professional in a number of ways. In one example, an IVR (interactive voice response system) of the prescription claims processing center 500 may receive the prescription request, and fax it to the medical professional. Alternatively, prescription request may first be routed to an IVR of the prescription service provider 590, who may then fax the prescription request to the medical professional. In another example, a medical professional who happens to be on-call when the prescription request is received may be paged. The prescription request may have been transmitted online from a website of the prescription claims processing center 500, or may have been transmitted via a cable server. Through the paging, the medical professional may be notified about the prescription request from the customer.

The medical professional may then review the prescription request, and if all is in order, may write a prescription order for the requested drug. The medical professional may send the prescription order that he wrote to the selected pharmacy 590 for fulfillment of the prescription. A number of different methods may be used by the medical professional to sent the prescription he wrote to the selected pharmacy, including but not limited to: faxing the written prescription to the pharmacy 590; phoning in the written prescription to the pharmacy 590, including phoning in the written prescription to an IVR of the pharmacy 590; e-mailing the written prescription to the pharmacy 590; and digitally scanning the written prescription to a remote scanner located in the pharmacy 590.

Upon receiving the prescription request, the prescription service provider 590 fulfils the prescription. Once the prescription has been filled by the prescription service provider 590, the prescription service provider 590 may deliver the filled prescription to the customer 105 within a desired time frame, as shown in act 540 in FIG. 5. Alternatively, the prescription service provider 590 may arrange for the delivery (e.g. by a delivery company hired by the prescription service provider 590) of the filled prescription to the customer 105 within the desired time frame. Alternatively, as shown in act 550, the prescription claims processing center 500 may arrange for the delivery of the filled prescription from the prescription service provider 500 to the customer 505. For example, the prescription claims processing center 500 may notify a delivery company (which may be hired by the prescription claims processing center 500) that the prescription has been filled and is ready, and may request the delivery company to pick-up and deliver the filled prescription to the customer. In particular, the prescription claims processing center 500 may request the delivery company to hand-deliver the filled prescription to the customer.

The delivery of the filled prescription to the customer 505 may be arranged so that same-day delivery is made to the customer, on the day of the request. Alternatively, next-day delivery may be made to the customer, within one day of the request. Alternatively, multiple same-day deliveries may be made, on the day of the request. Same day delivery to the customer's home or to the room of a hotel in which the customer is staying may greatly increase the convenience and speed of prescription services, and may not be offered by mail-order prescription delivery services.

Alternatively, the customer may be notified that the prescription has been filled and is ready for pick-up by the customer at the selected pharmacy 590. This is an alternative option that may be available, in addition to delivery of the filled prescription to the customer.

A variety of payment options may be available to the customers who purchase one or more of the expedited processing and delivery options described above. In one example, the customer may be charged by the selected pharmacy through the pharmacy's normal billing procedures. If the pharmacy actually delivered the prescription drug to the customer, the pharmacy may add the delivery fees to the cost of the prescription drug. Alternatively, a delivery company (which may be hired by the selected pharmacy or by the prescription claims processing center) may collect the delivery fee. Delivery fees may be paid COD to the delivering person, or may be included in the price of the prescription

Service fees for processing the prescription requests in the manner described above may be billed on demand, by analogy to charges to hotel guests for pay-per-view movies. Both in-room and in-home prescription service and delivery may be purchased on demand, on a case-by-case basis. Alternatively, charges for phoning in the prescription from home may be added to the customer's monthly home telephone bill. Alternatively, charges for submitting the prescription request from home may be added to the customer's monthly cable bill. Alternatively, a 900 phone number may be provided for in-home prescription requests.

The method and system described above may also be used for expedited processing and delivery of services other than prescription services, to greatly increase the convenience of the customers. These services may include, but are not limited to: grocery shopping and delivery; dry cleaning; car rental; food delivery (e.g. fast food or deli-food delivery); health care (e.g. medical, dental, nursing, and chiropractic care); hair care; and sales and delivery of consumer products (e.g. cell phones, toys, tools, DVDs, CDs, and records).

In sum, a method and system have been described for expedited processing and delivery of prescription services, and other type of services.

While the method and system have been particularly shown and described with reference to specific embodiments, it should be understood by those skilled in the art that various changes in form and detail may be made therein without departing from the spirit and scope of the invention.

What is claimed is:

1. A method of processing a prescription request for a customer that includes information about the geographic location of the customer, comprising:
receiving the request at a prescription claims processing center, including the information about the geographic location of the customer;
selecting a prescription service provider operating at a known geographic location from a plurality of prescription service providers, based on the received geographic location; and
routing the received request to the selected prescription service provider for fulfillment by the selected prescription service provider.

2. The method of claim 1, further comprising arranging for delivery of the filled prescription from the selected prescription service provider to the customer within a desired time frame.

3. The method of claim 2, wherein the delivery of the filled prescription within the desired time frame comprises at least one of:
same-day delivery on the day of the request;
next-day delivery within one day of the request; and
multiple deliveries on the day of the request.

4. The method of claim 1,
wherein each of the plurality of prescription service providers operate at known geographic locations, at least some of which are different from each other; and
wherein the act of selecting the prescription service provider comprises comparing the geographic location of the customer with the known geographic locations of the plurality of prescription service providers so as to identify a prescription service provider that is nearest to the geographic location of the customer.

5. The method of claim 4,
wherein the information about the customer's geographic location includes at least one of a zip code, a city name, a state name, an IP address, and a telephone area code of the customer's geographic location;
wherein the act of identifying the nearest prescription service provider comprises comparing at least one of zip codes, city names, state names, and telephone area codes of the known geographic locations with the information about the customer's geographic location.

6. The method of claim 1,
wherein the received geographic information includes at least one of a zip code, a city name, a state name, an IP address, and a telephone area code of the customer's geographic location;
wherein the act of routing the request to the selected prescription service provider comprises routing by at least one of the zip code, a city name, a state name, an IP address, and a telephone area code of the customer's geographic location.

7. The method of claim 1,
wherein the geographic location of the customer comprises a location of a commercial lodging facility at which the customer is staying at the time of the request; and
further comprising arranging for delivery of the prescription within the desired time frame to a room in the commercial lodging facility that is occupied by the customer at the time of the request.

8. The method of claim 1,
wherein the information about the geographic location of the customer comprises a home address of the customer; and
further comprising arranging for delivery of the prescription within a desired time frame to the home address of the customer.

9. The method of claim 2, wherein arranging for delivery comprises requesting a deliverer to pick up the filled prescription and to deliver the filled prescription to the customer.

10. The method of claim 1,
wherein the prescription claims processing center has at least one website that allows online submission of the request by the customer.

11. The method of claim 1, wherein receiving the request comprises at least one of:
receiving a phone call from the customer at a telephone number of the prescription claims processing center;
electronically receiving the request; and
receiving the request online from an Internet website of the prescription claims processing center.

12. The method of claim 11, further comprising publicly advertising the telephone number of the prescription claims processing center.

13. The method of claim 11,
wherein electronically receiving the request comprises at least one of:
receiving an electronic scan of the request from a remote scanner connected to the prescription claims processing center;
receiving a submission of the request through a TV channel;
receiving a transmission of the request through a cable network; and
receiving an e-mail transmission the request.

14. The method of claim 13, wherein the cable network comprises an internal TV cable network of a commercial lodging facility that provides interactive access to guests of the commercial lodging facility.

15. The method of claim 1,
wherein routing the request to the selected prescription service provider comprises at least one of:
routing the request to an interactive voice response system in the prescription service provider;
routing the request to an Internet website of the prescription service provider;
electronically transmitting the request to an electronic receiver located in the prescription service provider;
faxing the request to the prescription service provider;
e-mailing the request to an e-mail address of the prescription service provider; and
scanning the request into a scan receiver located in the prescription service provider.

16. The method of claim 1, wherein the selected prescription service provider is a pharmacy, and further comprising at least one of:
the prescription claims processing center transmitting the prescription request to a medical professional for the medical professional to write an order for the requested prescription drug; and
the prescription service provider transmitting the prescription request to a medical professional for the medical professional to write an order for the requested prescription drug.

17. The method of claim 16, further comprising selecting the medical professional operating at a known geographic location from a plurality of medical professionals; and
wherein the act of transmitting the prescription request to the medical professional comprises at least one of:
faxing the prescription request to the medical professional;
e-mailing the prescription request to the medical professional; and
paging the medical professional to notify the medical professional that the prescription request has been received.

18. The method of claim 16, further comprising the medical professional transmitting the order for the requested prescription drug to the selected pharmacy, for fulfillment by the selected pharmacy.

19. The method of claim 1,
wherein the prescription claims processing center comprises a system configured to receive and process claims from multiple pharmacies for prescriptions made by multiple manufacturers, to aggregate the received claims for the prescriptions made by each one of the multiple manufacturers, to obtain from each manufacturer a manufacturer rebate based on the aggregated claims for that manufacturer.

20. The method of claim 1,
wherein the prescription claims processing center comprises a system configured to receive and process claims from multiple pharmacies for prescriptions made by multiple manufacturers, to aggregate the received claims for the prescriptions made by each one of the multiple manufacturers, to obtain from each manufacturer a manufacturer rebate based on the aggregated claims for that manufacturer, and to allocate and distribute a pharmacy rebate to each one of the multiple pharmacies based on a portion of the manufacturer rebates.

21. The method of claim 1, further comprising storing in a database the request including the information about the geographic location of the customer.

22. The method of claim 1, further comprising notifying the customer to pick up the prescription from the selected service center when the prescription has been filled.

23. The method of claim 1, further comprising:
receiving multiple requests for prescriptions, each request including information about the geographic location of the customer who submitted the request, the information including at least one of a zip code, a city name, a state name, an IP address, and a telephone area code of the geographic location;
aggregating the received requests for at least one of the zip code, the city name, the state name, the IP address, and the telephone area code of each customer; and
storing the aggregated requests in a database.

24. The method of claim 1, wherein the plurality of prescription service providers comprise at least one of:
a pharmacy;
a medical institution; and
a medical professional.

25. The method of claim 9, further comprising asking the deliverer to hand-deliver the filled prescription to the customer within the desired time frame.

26. The method of claim 1, further comprising:
obtaining approval for the prescription request from a medical professional, before routing the request to the selected prescription service provider.

27. The method of claim 1, further comprising the selected prescription provider arranging for delivery of the filled prescription from the selected prescription service provider to the customer within a desired time frame.

28. A method of processing a request for a prescription for a customer that includes information about the geographic location of the customer, comprising:
receiving the request at a prescription claims processing center, including the information about the geographic location of the customer;
selecting a prescription service provider operating at a known geographic location from a plurality of prescription service providers, based on the received geographic location;
routing the received request to the selected prescription service provider for fulfillment of the prescription and delivery of the prescription to the customer by the selected prescription service provider within a desired time frame.

29. A system of processing a request for a prescription from a customer that includes information about the geographic location of the customer, the system comprising:
a processing system configured to receive the request including the information about the geographic location of the customer, the processing system further configured to select a prescription service provider operating at a known geographic location from a plurality of prescription service providers, based on the received geographic location, and to route the received request to the selected prescription service provider for fulfillment by the selected prescription service provider.

30. The system of claim 29, wherein the processing system is further configured to arrange for delivery of the filled prescription from the selected prescription service provider to the customer within a desired time frame.

31. The system of claim 29,
wherein each of the plurality of prescription service providers operate at known geographic locations, at least some of which are different from each other; and
wherein the processing system is further configured to compare the geographic location of the customer with the known geographic locations of the plurality of prescription service providers so as to identify a prescription service provider that is nearest to the geographic location of the customer.

32. The system of claim 29,
wherein the received geographic information includes at least one of a zip code, a city name, a state name, an IP address, and a telephone area code of the customer's geographic location; and
wherein the processing system is further configured to route the request to the selected prescription service provide by at least one of the zip code, the city name, the state name, the IP address, and the telephone area code of the customer's geographic location.

33. The system of claim 29, wherein the processing system is further configured to receive and process claims from multiple pharmacies for prescriptions made by multiple manufacturers, to aggregate the received claims for the prescriptions made by each one of the multiple manufacturers, to obtain from each manufacturer a manufacturer rebate based on the aggregated claims for that manufacturer, and to allocate and distribute a pharmacy rebate to each one of the multiple pharmacies based on a portion of the manufacturer rebates.

34. A method of processing a request for a service from a customer that includes information about the geographic location of the customer, comprising:
receiving the request at a service request processing center, including the information about the geographic location of the customer;
selecting a service provider operating at a known geographic location from a plurality of service providers based on the received geographic location; and
routing the received request to the selected service provider for delivery of the service by the selected service provider to the customer within a desired time frame.

35. The method of claim 34, wherein the service comprises at least one of:
grocery shopping and delivery;
dry cleaning;
car rental;
food delivery;
health care,
hair care; and
sales and delivery of consumer products.

36. The method of claim 35, wherein the health care service comprises at least one of: medical care service, dental care service, nursing service, chiropractic service, and physical therapy service.

37. The method of claim 36, wherein the consumer products include at least one of: cell phones; toys; tools; DVDs; CDs; and records.
